(19) United States
(12) Patent Application Publication
(10) Pub. No.: US 2024/0202198 A1
(43) Pub. Date: Jun. 20, 2024

(54) CONTINUOUS QUERY USING ANCHORED PATHS

(71) Applicant: Microsoft Technology Licensing, LLC, Redmond, WA (US)

(72) Inventor: Allen Geoffrey JONES, Irvine, CA (US)

(21) Appl. No.: 18/082,717

(22) Filed: Dec. 16, 2022

(51) Int. Cl. G06F 16/2455; G06F 16/23; G06F 16/2453

(52) U.S. Cl. CPC G06F 16/24568; G06F 16/2358; G06F 16/24539

(57) ABSTRACT

The present disclosure relates to methods and systems for running continuous queries over change queues received from a source database and reacting dynamically to the incremental results from the change queues. The methods and systems calculate and cache the continuous query results for the continuous query and update the continuous query results over time in response to changes made in a source database. The methods and systems trigger a reaction in response to the source database changes that result in changes in the continuous query results.

### BACKGROUND

A typical query on a database is a request response interaction pattern with immediate results from the database. A query is generally issued against a point in time snapshot of the database and the results include projections from all records that match the query criteria at the time of execution of the query. Subsequent changes to the data in a database that would alter the original query result remain unknown to the original query issuer until another query is issued on the database. At which point, the results of the query may change if the changes in the database are relevant to the query.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes extracting a set of features from a change event with a change related to a continuous query active on a source database. The method includes using the set of features to determine an impact to continuous query results based on the change. The method includes outputting the impact to the continuous query results.

Some implementations relate to a device. The device includes a processor; memory in electronic communication with the processor; and instructions stored in the memory, the instructions being executable by the processor to: extract a set of features from a change event with a change related to a continuous query active on a source database; use the set of features to determine an impact to continuous query results based on the change; and output the impact to the continuous query results.

Some implementations relate to a method. The method includes receiving a change event with a change related to a continuous query active on a source database. The method includes accessing a graph of the source database from a cache. The method includes identifying a node in a graph of the source database with the change. The method includes determining before change solutions of the continuous query with the node. The method includes applying the change to the node. The method includes determining after change solutions of the continuous query with the node. The method includes identifying a difference between the before change solutions and the after change solutions. The method includes outputting the difference, wherein the difference identifies an impact to continuous query results in response to the change.

Some implementations relate to a device. The device includes a processor; memory in electronic communication with the processor; and instructions stored in the memory, the instructions being executable by the processor to: receive a change event with a change related to a continuous query active on a source database; access a graph of the source database from a cache; identify a node in a graph of the source database with the change; determine before change solutions of the continuous query with the node; apply the change to the node; determine after change solutions of the continuous query with the node; identify a difference between the before change solutions and the after change solutions; and output the difference, wherein the difference identifies an impact to continuous query results in response to the change.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for use with continuous queries in accordance with implementations of the present disclosure.

FIG. 2 illustrates an example reactive graph component for use with implementations of the present disclosure.

FIG. 3 illustrates an example query node for use with implementations of the present disclosure.

FIG. 4 illustrates an example query host for use with implementations of the present disclosure.

FIGS. 5A and 5B illustrate an example of a query in accordance with implementations of the present disclosure.

FIG. 6 illustrates an example of processing a query in accordance with implementations of the present disclosure.

FIG. 7 illustrates an example graph in accordance with implementations of the present disclosure.

FIG. 8 illustrates an example source change event in accordance with implementations of the present disclosure.

FIGS. 9-14 illustrate an example of solving continuous queries using anchored paths in accordance with implementations of the present disclosure.

FIG. 15 illustrates an example of updates to a continuous query result in accordance with implementations of the present disclosure.

FIG. 16 illustrates an example method for determining an impact of a change on continuous query results in accordance with implementations of the present disclosure.

FIG. 17 illustrates an example method for determining an impact of a change on continuous query results in accordance with implementations of the present disclosure.

FIG. 18 illustrates components that may be included within a computer system.

### DETAILED DESCRIPTION

This disclosure generally relates to continuous queries. A typical query on a database is a request response interaction pattern with immediate results from the database. A query is generally issued against a point in time snapshot of the database and the results include projections from all records that match the query criteria at the time of execution of the query. Subsequent changes to the data in a database that would alter the original query result remain unknown to the original query issuer until another query is issued on the database. At which point, the results of the query may change if the changes in the database are relevant to the query.

A continuous query is a long running query where a request is provided for the continuous query without receiving immediate results for the continuous query. The continuous query remains active against the database, observing all database changes. Results are provided for the continuous query in response to updates to the data in the database that impact the results of the continuous query. Data may be added to or removed from the continuous query results due to individual changes in the data of the database. As such, the continuous query is a standing request on the database that waits for results from the database. The continuous query results are proactively sent to subscribers (e.g., users, applications, or services) that registered an interest in the continuous query results generated by a continuous query. The continuous query results are sent in response to changes in the source database that change the continuous query results.

The present disclosure is directed to systems and methods for running continuous queries over change queues from a source database and reacting dynamically to the incremental results from the change queues. The systems and method use a reactive graph service to run continuous queries over a source database. In some implementations, the source database is a graph database. In some implementations, the source database is a relational database. The reactive graph service calculates and caches the continuous query results for the continuous query and updates the continuous query results over time in response to changes made in the source database. The reactive graph service triggers a reaction in response to database changes that result in changes in the continuous query results. The reaction takes the continuous query result changes as input and provides an action on the continuous query result. The action is based on a functionality of the reaction. For example, the reaction is dispatching an update via e-mail to subscribers of the continuous query.

The systems and methods monitor the changes in data of the source databases and determine whether the changes impact the continuous query results of a continuous query (add results to the continuous query results, updates results currently in the continuous query results, or remove results from the continuous query results). The systems and methods evaluate the changes in the data of the source database and routes the received changes to the query nodes hosting continuous queries that may be interested in the changes to the data of the source databases. The continuous queries in the receiving query nodes determines if the change has any effect on the continuous query results. If changes have occurred to the continuous query results, the difference between the result before and after the change are calculated (added, updated, deleted). Then updates to the continuous query results are dispatched to subscribers of the continuous query.

In some implementations, a graph of the data from the source database related to the continuous query is used to analyze an impact of the change on the continuous query results. The systems and methods identify an anchor node in the graph (e.g., a node that changed) and perform a graph walk (e.g., anchored path walks) from the anchor node to determine possible solutions (e.g., continuous query results) to the continuous query using the anchor node prior to the change occurring. The systems and methods apply the change to the anchor node in the graph and perform a graph walk from the anchor node with the change to determine possible solutions (e.g., continuous query results) to the continuous query using the anchor node after the change occurred. The systems and methods use the solutions prior to the change and the solutions after the change to identify whether changes occurred to the continuous query results. If no changes occurred (e.g., the solutions are the same prior to the change and after the change), the systems and methods may ignore the change. If a change occurred (e.g., the solutions are different prior to the change and after the change), the systems and methods output the changes in the continuous query results. The systems and methods may perform one or more reactions in response to receiving the changes in the continuous query results.

One example use case of the present disclosure includes incident alerting in response to an incident occurring in a region. Managers of employees contact the employees located in geographical regions where critical incidents occur to verify that the employees are safe. To perform incident alerting with traditional queries, the systems run the queries periodically (every minute, every hour, etc.) to determine if any action is required for the query adding unnecessary load on the server to spin up the query and process the results. Instead, the methods and systems of the present disclosure use continuous queries on the source database with the employee information. The managers create a continuous query for notifications of critical incidents occurring in regions where the employees are located. The managers may use the notifications to verify the safety of the employees located in the geographic regions where the critical incidents occurred. The methods and systems of the present disclosure monitor changes in the data of the source database to determine whether the continuous query results are impacted by the change. The changes in the data may add results to the continuous query, update results to the continuous query, or remove results from the continuous query. One or more reactions occurs with actions in response to changes in data that impact the continuous query results. For example, in response to a critical incident occurring in a region, an action includes triggering code to automatically send an e-mail to the identified employees located in the region where the critical incident occurred. Another example action includes triggering code that updates a database. Another example action includes launching a process.

Instead of running a query to get results, the systems and methods of the present disclosure take a continuous query and turn the continuous query into a set of patterns and/or rules that determines how a change affects the overall results of the continuous query.

One technical advantage of the systems and methods of the present disclosure is a cost effective way to have a large volume of continuous queries active observing the changes in the databases with the potential to trigger as opposed to having thousands of independent processes periodically going to check to if something is changing for a traditional query. Another technical advantage of the systems and method of the present disclosure is maintaining perpetually accurate continuous query results based on the change log records from the source databases the continuous queries have processed. Another technical advantage of the systems and methods of the present disclosure is triggering process automation using the continuous queries. Another technical advantage of the systems and methods of the present disclosure is reacting spontaneously to real-world observations using the continuous queries. Another technical advantage of the systems and methods of the present disclosure is enabling cross-system and cross-organization integration. Another technical advantage of the systems and methods of the present disclosure is powering proactive user experiences using the continuous queries.

As such, the systems and methods of the present disclosure analyze raw changes to the source database to determine whether the individual change has an overall effect on the continuous query results. If a change occurs in the continuous query results, the continuous query results are output, and a reaction may occur in response to the change. Any subscribers that registered an interest in the continuous query are notified of the changes to the continuous query results and/or receives the reaction identified in the subscription of the continuous query.

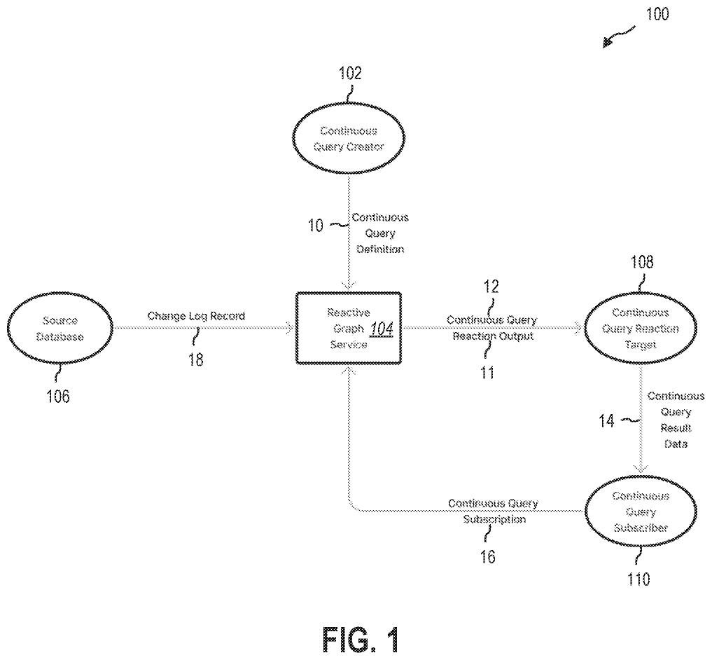

Referring now to FIG. 1, illustrated is an example environment 100 for use with continuous queries. The environment 100 includes a continuous query creator 102 that uses the reactive graph service 104 for use with continuous queries 12. A continuous query 12 is a long running query that provides query results in response to changes made in the source database 106 that impact the continuous query 12. In some implementations, the source database 106 is a graph database. In some implementations, the source database 106 is a relational database. The continuous query 12 is a standing request on the source database 106 and the continuous query results 14 are proactively sent in response to changes in the source database 106 impacting the continuous query results 14. For example, the continuous query 12 is to identify any ship in the fleet that is sailing and the continuous query results 14 are generated as the status of ships in the fleet change (change from in port to sailing and from sailing to in port).

The continuous query creator 102 creates continuous queries 12 on the reactive graph service 104. The continuous query creator 102 provides the reactive graph service 104 with continuous query definitions 10 for the continuous query(s) 12. The continuous query definitions 10 include which source databases 106 the continuous query 12 receives data from and a query that describes what data the continuous query 12 is interested in and what data to include in the continuous query results 14 generated by the continuous query 12. Each continuous query 12 has an individual continuous query definition 10.

The query definition 10 includes a match pattern with one or more match paths and a plurality of match path elements. The continuous query 12 may include any number of match paths and/or match path elements. The match path elements and the match path(s) identify the features of the continuous query 12. The continuous query 12 also includes a query projection that describes what data elements are extracted from solutions in the source database 106 that match the match pattern. The continuous query 12 also includes a query projection that filters out the matching data to different solutions. In some implementations, the continuous query 12 is expressed as a CYPHER query.

The continuous query creator 102 is any device, program, process, application, and/or service that uses the reactive graph service 104. In some implementations, a user of the device, program, process, application, and/or service creates the continuous query 12 and provides the continuous query definitions 10. In some implementations, the user creates a plurality of continuous queries 12 where each continuous query 12 has a unique continuous query definition 10.

The reactive graph service 104 starts a continuous query 12 in response to receiving the continuous query definitions 10 from the continuous query creator 102. An initial set of data is loaded from the source database 106 identified in the continuous query definitions 10 in response to the continuous query 12 starting. The initial set of data bootstraps the continuous query results 14 generated by the continuous query 12 by providing an initial set of data for the continuous query results 14.

The reactive graph service 104 starts processing the change log record 18 provided by the source database 106. The source database 106 generates a change log record 18 containing all changes made to the source database 106. The change log record 18 is provided to the reactive graph service 104 in sequence.

The continuous queries 12 evaluate all source databases 106 changes included in the change log records 18 to determine if a change is relevant to the continuous query 12, and if so, whether the change has any effect on the continuous query results 14. If the continuous query results 14 changes due to a database change received in a change log record 18, the continuous query 12 determines the specific effect on the continuous query results 14 (additions, updates, or deletions). As such, the continuous queries 12 maintain a perpetually accurate continuous query result 14 based on the change log records 18 the continuous queries 12 have processed.

The continuous query 12 dispatches any continuous query result 14 updates (e.g., additions, updates, or deletions to the continuous query results 14) to the continuous query subscribers 110. The continuous query subscribers 110 create a continuous query subscription 16 that registers interest in the continuous query results 14 generated by a continuous query 12.

In some implementations, the continuous query subscriber 110 is a user and the continuous queries 12 are available continuous queries 12 that are already created. For example, a user accesses a list of available continuous queries 12 and selects one or more continuous queries 12 from the list of available continuous queries 12 for the continuous query subscription(s) 16. In some implementations, the continuous query subscriber 110 is an application or service creates the continuous query subscription 16 that registers interest in the continuous query results 14 generated by a continuous query 12. For example, the continuous query 12 is used by the application or service to provide information to users of the application or service. Another example includes the continuous query 12 is used by the application or service to perform actions based on the continuous query results 14.

The continuous query 12 continues to run until stopped. For example, the continuous query creator 102 provides instructions to the reactive graph service 104 to stop the continuous query 12.

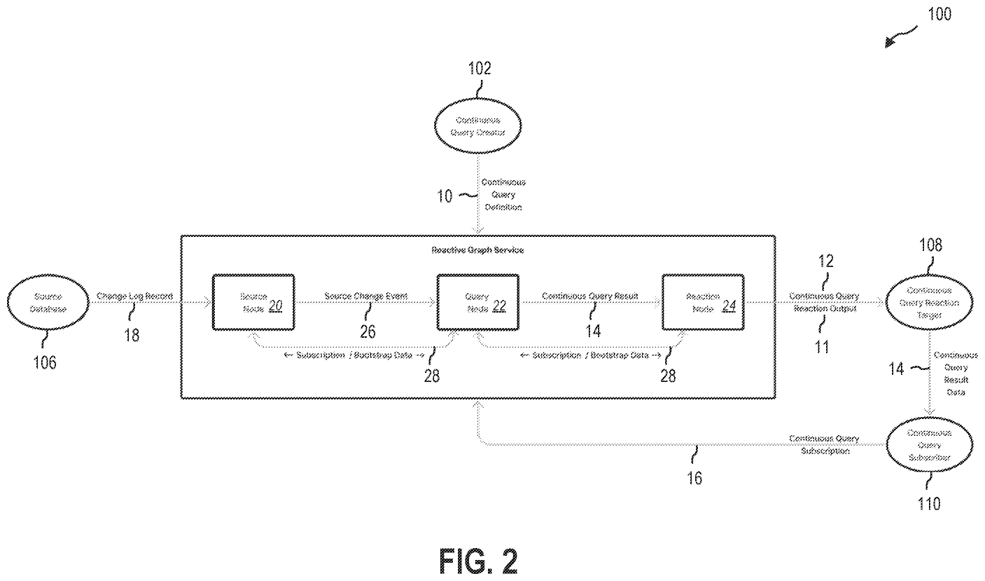

Referring now to FIG. 2, illustrated is an example reactive graph service 104 for use with the environment 100. The reactive graph service 104 includes a query node 22 in communication with a source node 20 and a reaction node 24. The query node 22 is a collection of services that host continuous queries 12. The reactive graph service 104 assigns a query node 22 to a continuous query 12 in response to the continuous query creator 102 creating the continuous query 12. In some implementations, the query node 22 is assigned a single continuous query 12. In some implementations, the query node 22 is assigned multiple continuous queries 12.

The source node 20 is a collection of services that handle bi-directional communications with the source databases 106. The source node 20 communicates with the source database 106 and represents the source database 106 to the query node(s) 22. In some implementations, there is one source node 20 per source database 106. For example, a human resource source database is associated with a human resource source node, a facilities source database is associated with a facilities source node, and an incidents source database is associated with an incident source node. The source node 20 provides a secure connection to the source database 106.

The source node 20 also processes the continuous query subscriptions 16 from the query nodes 22 that request 28 the source node 20 to query the source database 106 to get initial data that is used to bootstrap the continuous queries 12 when the continuous queries 12 are first created. The query node 22 actively subscribes to the appropriate source node 20 by sending a request 28 to the source node 20 that describes the types of nodes/relations that the query node 22 is interested in so that the source node 20 knows what type of changes to forward to the query node 22 for processing.

The source node 20 processes the database change log records 18 and forwards source change events 26 to the query node 22. The source change events 26 are changes to the database change log records 18. The source node 20 discards any unrelated changes to the continuous query 12 and provides any changes that are related to the continuous query 12 to the query node 22 with the continuous queries 12 (e.g., the changes may impact the continuous query 12). In some implementations, the source change events 26 may be related to a plurality of continuous queries 12 In some implementations, the change events may be relevant to a plurality of continuous queries, and thus, a plurality of query nodes 22 receive the same source change events 26.

An example use case includes the source node 20 receives the change queue 32 from the source database 106 with change events that provide maintenance updates for a building. The change events indicate that a maintenance log was added, a wall was painted in the building, repairs occurred to the basement of the building, and a temperature reading from a room. The query node 22 provides a request 28 to the source node 22 for measurements relating to room comfort levels in a building in response to the continuous query 12 being created for measuring room comfort levels in the building. The query node 20 discards the change event indicating that a maintenance log was added, a wall was painted in the building, and repairs occurred to the basement of the building in response to determining that the change events are unrelated to the information requested by the query node 22 (measuring room comfort levels in a building). However, the query node 20 provides the changes with the temperature reading from the room to the query node 20 hosting the continuous query 12 in response to determining that the temperature reading from the room may impact the continuous query 12 for measuring room comfort levels in a building.

The reaction node 24 is a collection of services that handle reactions 11. The reactions 11 are code that is used to react to updates to the continuous query results 14. For example, the reactions 11 may send updates to some kind of queue for processing or communicate directly with some other software system. Another example of the reactions 11 is automatically lowering a thermostat in a room in response to receiving the continuous query results 14 indicating that the room temperature is above a threshold.

The continuous query subscription 16 includes a reaction 11 that describes how the continuous query results 14 are delivered from the reactive graph service 104 to the continuous query subscriber 110. The reaction 11 takes the continuous query results 14 changes as input and provides an action on the continuous query result 14. The action is based on a functionality of the reaction 11. The reaction 11 is configured as part of a subscription 16 to handle updates to the continuous query results 14. For example, a reaction 11 is forwarding updates the continuous query results 14 to any destination for further processing. Another example of a reaction 11 is sending a webhook to a web address. A continuous query 12 may have multiple continuous query subscriptions 16, and each continuous query subscription 16 may contain one or more reactions 11.

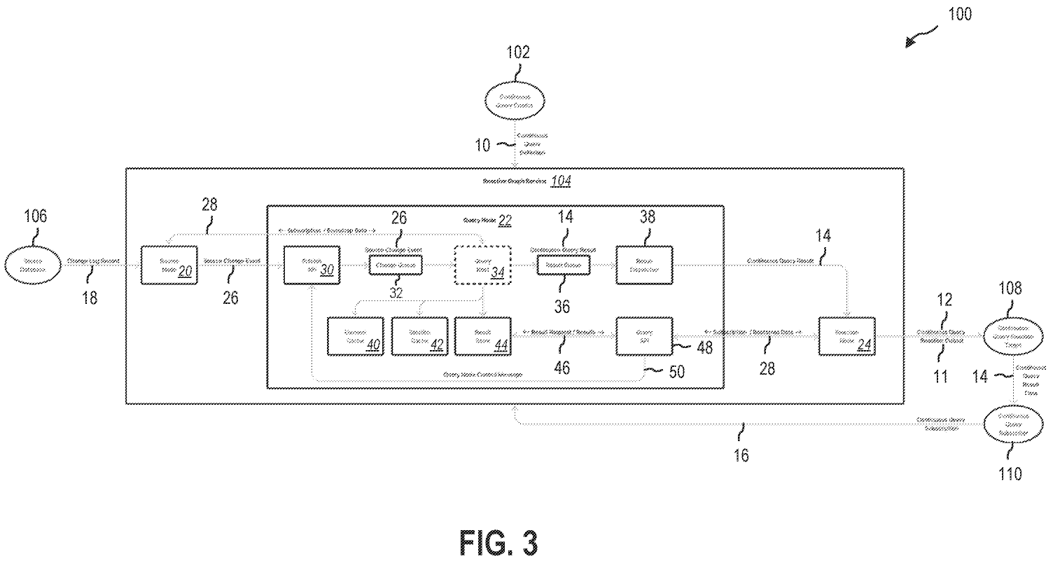

Referring now to FIG. 3, illustrated is an example query node 22 for use with the reactive graph service 104. The query node 22 includes a publish API 30. The source node 20 publishes the source change events 26 to the publish API 30 of the query node 22. The publish API 30 pushes the source change events 26 into a change queue 32.

The query host 34 pulls the source change events 26 from the change queue 32 and passes the change queue 32 to one or more continuous queries 12 for processing. In some implementations, the query host 34 hosts multiple continuous queries 12. The query host 34 processes each inbound change event included in the source change events 26 to determine if the changes to the source database 106 cause changes to the continuous query results 14.

If a database change described in the source change events 26 causes changes (additions, deletions, or updates) to the continuous query results 14, the changes are pushed as continuous query results 14 to the result queue 36. The result dispatcher 38 takes the continuous query results 14 from the result queue 36 and dispatches the continuous query results 14 to the reaction node 24.

The element cache 40 holds a copy of the current and previous states of each database element (nodes and relations) that is possibly relevant to each continuous query 12 (e.g., the database element could be part of a solution/result for the continuous query 12). The element data (nodes and relations) is cached/stored in a featurized/minimal form, retaining only what information is relevant to the continuous query 12, in order to reduce storage overhead.

The solution cache 42 holds a copy of each continuous query solution and an index of which elements (nodes and relations) are a component of each solution. The result store 44 holds a copy of the current and all historical continuous query results 14 for each continuous query 12.

The query API 48 provides the means through which the continuous query subscribers 110 subscribe to the continuous queries 12, and through which requests 46 can be made for the current and historical continuous query results 14. The continuous query subscribers 110 provide a query identification (ID) and a reaction ID of the continuous queries 12 that the query subscribers 110 are subscribing to. The query API 48 provides a query node control message 50 (e.g., a subscription message) with the query ID(s) and the reaction ID(s) to the publish API 30. The publish API 30 places the query node control message 50 in the change queue 32. The query node control message 50 is processed by the query host 34 and informs the specified continuous query 12 (e.g., the continuous query 12 associated with the query ID) to send the output of the continuous query 12 to the subscribed reaction. 11 (e.g., the reaction 11 associated with the reaction ID).

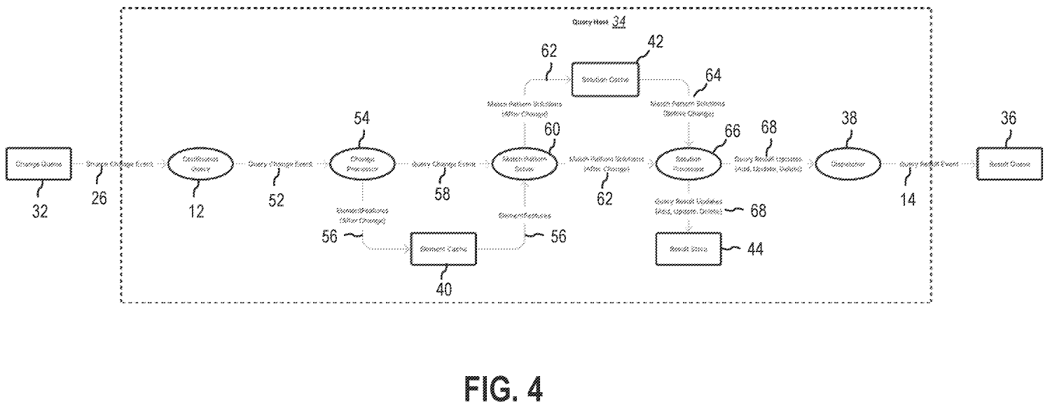

Referring now to FIG. 4, illustrated is an example query host 34 for use with the reactive graph service 104. The publish API 30 (FIG. 3) places the source change event 26 in the change queue 32 in the sequence the source change events 26 are provided by the source database 106 (FIG. 3) change log records 18 (FIG. 3).

The continuous query 12 takes the source change events 26 from the change queue 32 for processing. The source change events 26 are processed sequentially, there is no parallel processing of the source change events 26 within a single continuous query 12. The continuous query 12 processing ensures the source change event 26 is relevant to the continuous query 12. If the source change event 26 is relevant to the continuous query 12, the continuous query 12 transforms the source change event 26 into a query change event 52. The transformation includes extracting relevant features from the changed element (node or relation) contained in the source change event 26.

The query host 34 extracts features from the source change queue 32 that may be relevant to the continuous query 12. The source change queue 32 may include additional data that is unrelated to the continuous query 12. For example, the continuous query 12 is measuring room comfort levels in a building and the source change queue 32 includes the temperature reading of the room, room assignment information, maintenance schedule for the room, and a type of flooring for the room. The query hosts 34 evaluates the source change queue 32 and extracts the temperature reading of the room as the relevant data from the source change queue 32 for the continuous query 12 and discards the remaining data of the source change queue 32 (room assignment information, maintenance schedule for the room, and type of flooring for the room).

The query host 34 performs the feature extraction based on the match path elements included in the match pattern of the continuous query 12, the query predicate, and the query projection of the continuous query 12. For example, if the feature in the change queue 32 is the same as the match path elements, the query host 34 extracts the feature from the change queue 32. In some implementations, the query host 34 extracts the minimum features from the change queue 32 that are important to the continuous query 12. For example, the minimum features from the change queue 32 that are important to the continuous query 12 is a feature that matches a match path element included in the match pattern of the continuous query 12.

The continuous query 12 processes the query change event 52 and passes the query change event 52 to a change processor 54. The change processor 54 adds the featurized updated element 56 to the element cache 40 and invokes the match pattern solver 60 providing the query change event 58 (and the featurized updated element 56 it contains) to serve as the anchor element for the match pattern solver 60.

The match pattern solver 60 finds solutions to the continuous query 12 starting with the anchor element and using the content of the element cache 40. The match pattern solver 60 stores successful solutions 62 in the solution cache 42 and passes the successful solutions 62 to the solution processor 66.

The solution processor 66 gets solutions 64 that the anchor element was previously part of from the solution cache 42 and compares the solutions 64 that the anchor element was previously part of with the solutions 62 generated by the match pattern solver 60 to determine if the database change caused any changes to the continuous query results 14. In some implementations, the continuous query results 14 remain the same and the change identified in the math pattern solutions 62 does not affect the continuous query results 14 and the query host 34 may discard or otherwise ignore the query change event 58.

If changes occurred to the continuous query results 14 (deletion, updates, additions), the solution processor 66 calculates which continuous query results 14 where added, updated, and deleted. The solution processor 66 stores the updates 68 in the result store 44 and forwards the updates 68 (changes to the continuous query results 14) to the dispatcher 38 for dispatch to continuous query subscribers 110 and their reactions 11 via the result queue 36.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the reactive graph service 104 and the source database 106 are implemented wholly on the same computing device. Another example includes one or more subcomponents of the reactive graph service 104 (e.g., the source node 20, the query node 22, and the reaction node 24), and the source database 106 are implemented across multiple computing devices. Moreover, in some implementations, one or more subcomponent of the reactive graph service 104, the source database 106, the continuous query creator 102, the continuous query reaction target 108, and the continuous query subscriber 110 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 analyzes raw changes to the source database 106 to determine whether the individual changes have an overall effect on the continuous query results 14.

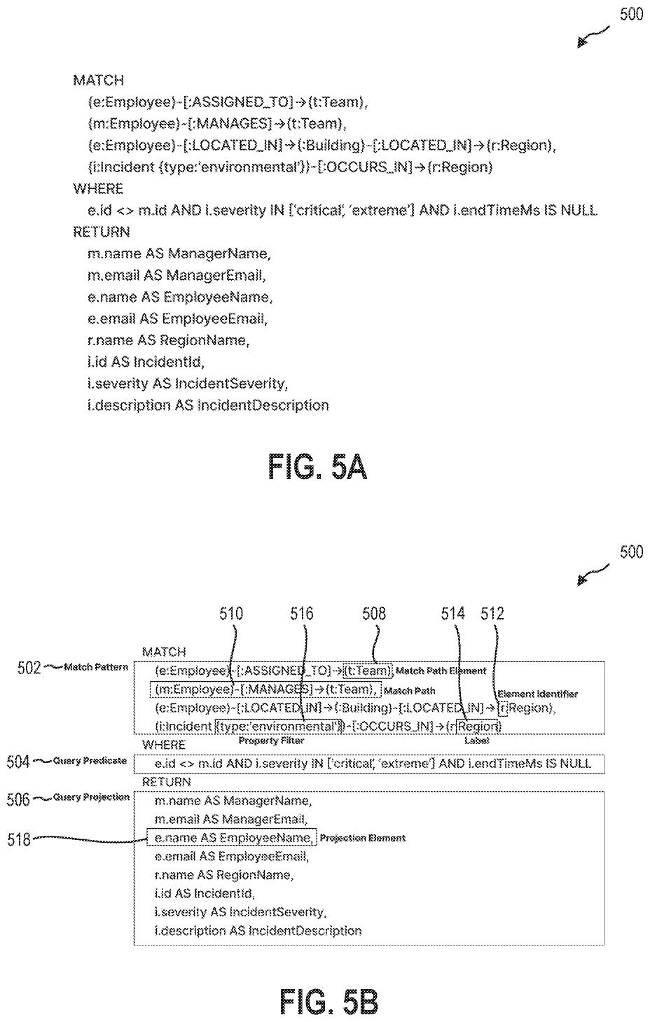

Referring now to FIG. 5A, illustrated is an example query 500 expressed using CYPHER graph query language. The query 500 will, for each team manager, generate a list of employees assigned to their team that are located in buildings located in a region where there is a ‘critical’ or ‘extreme’ severity incident occurring. The query results may be used to generate an email to the team manager so the team manager may check that the employee is OK or if the employee needs assistance.

Referring now to FIG. 5B, illustrated is the anatomy of the query 500 as used in the context of a continuous query 12 (FIG. 1). The query 500 includes a match pattern 502. The match pattern 502 includes a plurality of match path elements (e.g., match path element 508 (team)). The match pattern 502 may include one or more match paths (e.g., match path 510 (the manager's team)) that contain one or more match path elements. The match paths may include an element identifier 512 (region), a property filter 516 (environmental incident), and a label 514 (environmental incident occurs in the region). The match path elements and the match path(s) identify the features of the continuous query 12 to match for the continuous query 12.

In some implementations, the match path elements are represented as match path element feature vectors. By representing the match path elements as feature vectors using a binary representation, the amount of data cached for the match paths elements is minimized while maximizing the performance of the query host 34 in identifying whether the features included in the query change event 52 match each match path element for the match path (e.g., match path 510). In some implementations, the feature vectors are stored in the element cache 40 and the query host 34 obtains the feature vectors for the continuous query 12 from the element feature cache 40.

The query 500 also includes a query predicate 504 that specifies additional constraints that must be true for a possible solution that to be included in the query result. The query 500 also includes a query projection 506 that filters out the matching data to different solutions. The query projection 506 may include a plurality of projection elements (e.g., projection element 518 (employee name)).

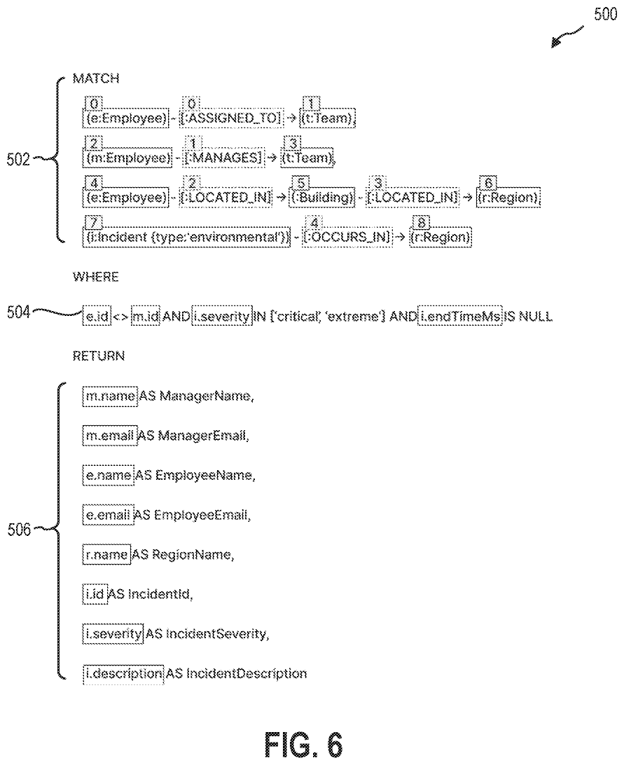

Referring now to FIG. 6, illustrated is an example of processing the query 500 (FIGS. 5A, 5B) using the match pattern solver 60 (FIG. 4). When a continuous query 12 is created by the continuous query creator 102 (FIG. 1), the query host 34 (FIG. 4) assigned to the continuous query 12 analyzes the cypher query 500 for the continuous query 12 and configures the match pattern solver 60 specifically to find solutions 62 (FIG. 4) to the query 500 starting from a single anchor element and using the element cache 40 (FIG. 4) to find the rest of the elements to complete the solutions 62.

In the query 500, from the match clause, the match pattern solver 60 identifies 9 match path elements (e.g., match path element 508, FIG. 5) where nodes (node 0, node 1, node 2, node 3, node 4, node 5, node 6) go (solid lines), and 5 match path elements where relations (relation 0, relation 1, relation 2, relation 3, relation 4) go (dotted lines). For each of those match path elements, we use the provided labels and property Filters (see node 7) to generate evaluators that can take a graph node or relation and determine if the graph node or relation is a suitable match path element solution to fill that match path element. After locating a specific anchor element, if the match pattern solver 60 finds match path element solutions for every path element, a possible match path solution is identified by the match pattern solver 60, subject to the validation of the query predicate 504.

The WHERE clause, if present, contains the query predicate 504 which must evaluate to true for a possible match path solution to be a valid solution 62 to the query 500. The RETURN clause includes the query projection 506 and defines the content to project from the match path element solution elements of a valid match path solution and include in the continuous query results 14.

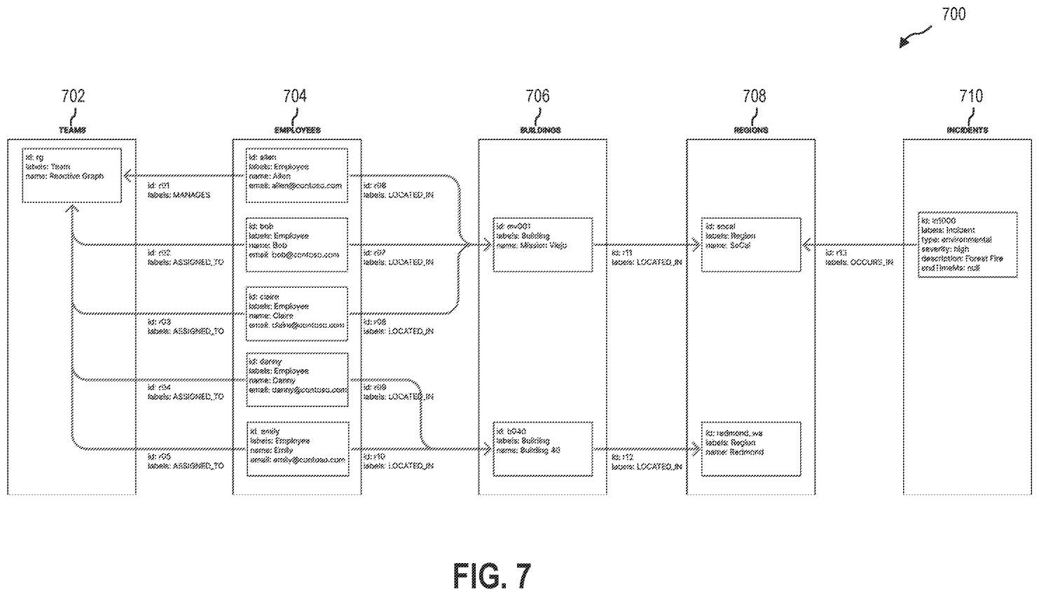

Referring now to FIG. 7, illustrated is an example graph 700. The graph 700 includes nodes (boxes) and relations (lines). For example, the graph 700 is a human resource system with nodes (boxes) representing teams 702, employees 704, buildings 706, regions 708, and incidents 710. The relations (lines) describe the relationships between those nodes (e.g., assigned to a team, located in a region or building, etc.). The human resource system also contains the incidents 710 (important events) occurring in the regions 708. For example, the query host 34 obtains the graph 700 with data from a source database 106 that is related the continuous query 12 hosted by the query host 34.

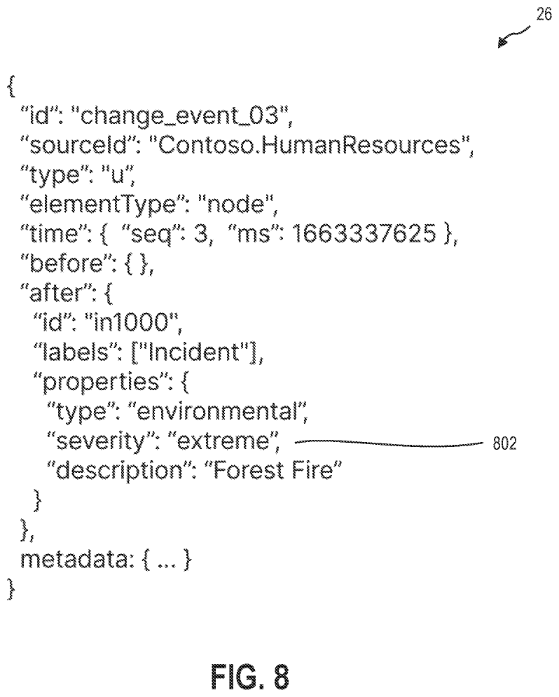

Referring now to FIG. 8, illustrated is an example source change event 26 received from a source database 106 (FIG. 1) for the query 500 (FIGS. 5A, 5B). The source change event 26 updates the severity property 802 of the in1000 Incident node in the graph 700 (FIG. 7) from ‘high to ‘extreme.’ For example, the query node 22 hosting the continuous query 12 receives the source change event 26 from the source database 106 with changes that are relevant to the continuous query 12.

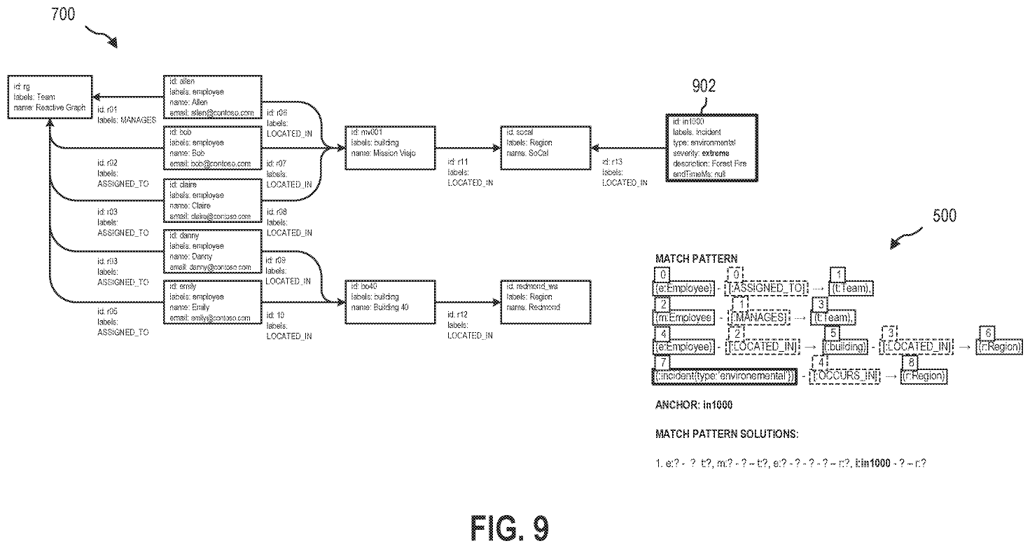

Referring now to FIGS. 9-14, illustrated is an example of solving continuous queries 12 using anchored paths using the graph 700 and the query 500. The query host 34 uses the source change event 26 received from the source database 106 and the graph 700 to solve the continuous query 12 using anchored paths. FIG. 9 illustrates an anchor node 902 from which to generate possible solutions for the continuous query 12.

The continuous query 12 transforms the source change event 26 illustrated in FIG. 8 into a query change event 58, which extracts the changed node (in1000) and evaluates the changed node (in1000) suitability for each of the match path elements of the query 500. In this case, the changed node (in1000) is only suitable for the node match path element 7 (node 7), because node 7 is a node that has an incident label and it has a type of property with a value of ‘environmental’, as required by the node 7 property filter. The match pattern solver 60 identifies the in1000 Node as the anchor node 902 from which to generate solutions. The match pattern solver 60 creates an initial partial match pattern solution containing only the in1000 Node id.

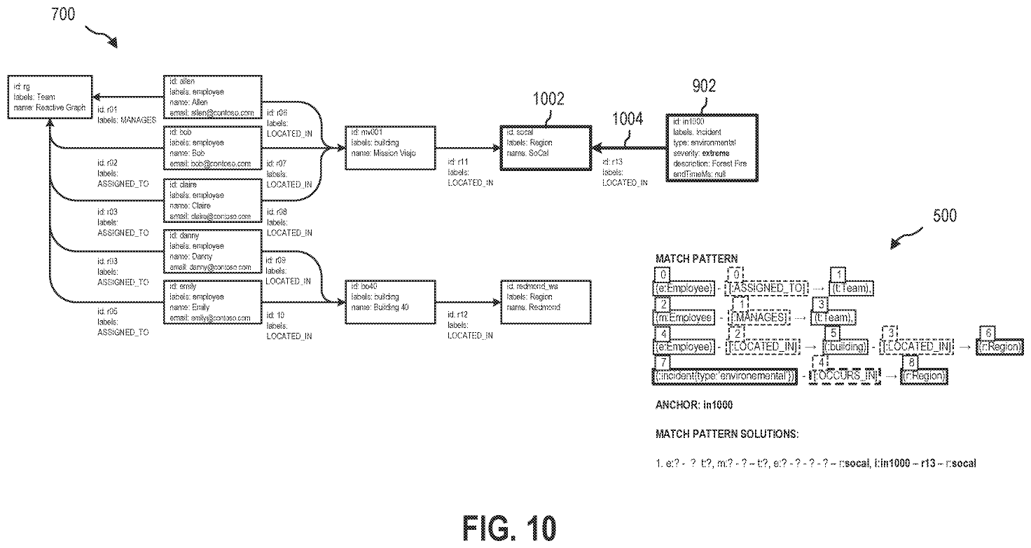

FIG. 10 illustrates the anchor node 902 and a connected node 1002 to the anchor node 902 as part of a partial match pattern solution to the continuous query 12. The match pattern solver 60 queries the element cache 40 for relations that satisfy the relation R4 connected to nodes that satisfy the node match path element 8 (node 8). Based on all previously processed updates, the match pattern solver will find a single pair: relation r13 1004 and node socal 1002. The match pattern solver 60 adds the IDs (relation r13 and node socal 1002) to the existing partial match pattern solution. Also, because node 8 is assigned the identifier ‘r’ in the query 500, the match pattern solver can assume that any other match path elements that also have an identifier ‘r’, such as node 6, are also social in this solution. This technique of jumping match paths using common identifiers is central to the anchored path approach to solving continuous queries 12.

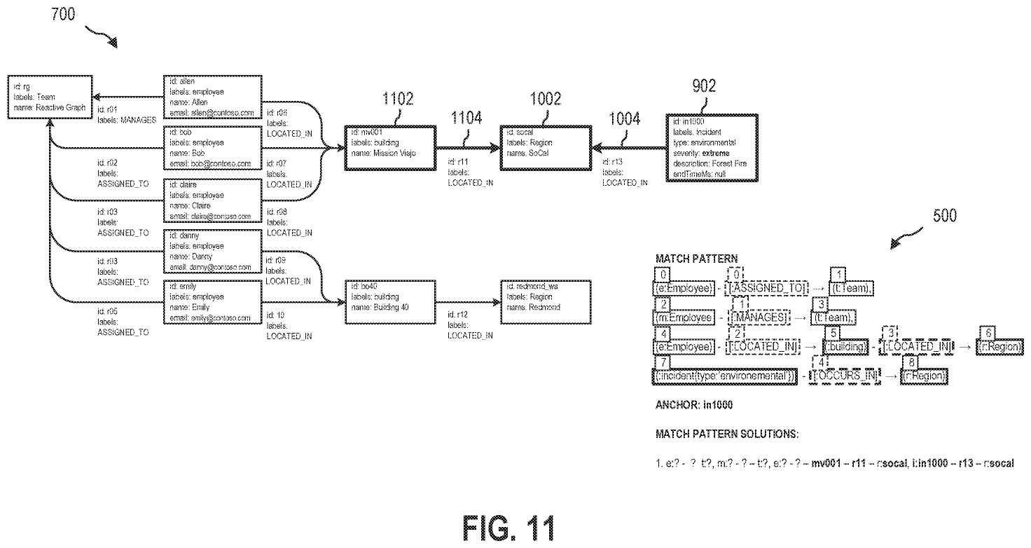

FIG. 11 illustrates the anchor node 902 and connected nodes 1002, 1102 as part of a partial match pattern solution to the continuous query 12. The match pattern solver 60 queries the element cache 40 for relations that satisfy relation 3 connected to nodes that satisfy node 5. The match pattern solver 60 finds relation r11 1104 and node mv001 1102. The match pattern solver 60 add the IDs (relation r11 1104 and node mv001 1102) to the existing partial match pattern solution.

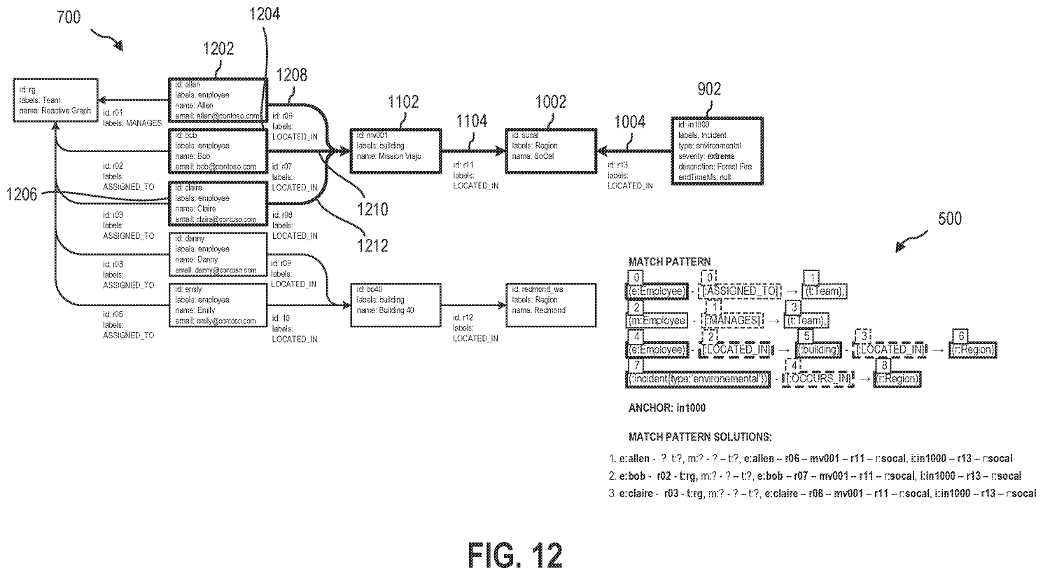

FIG. 12 illustrates the anchor node 902 and connected nodes 1002, 1102, 1202, 1204, and 1206 as part of a partial match pattern solution to the continuous query 12. The match pattern solver 60 queries the element cache 40 to find relations that satisfy relation R2 connected to the nodes that satisfy node N4. The match pattern solver 60 finds three relation/node pairs (node 1202, relation 1208; node 1204, relation 1210; and node 1206, relation 1212). The match pattern solver 60 uses one pair to extend the current partial match pattern solution, and creates two additional partial match pattern solutions, for a total of three partial match pattern solutions for the continuous query 12. Also, because node N4 is assigned the identifier ‘e’ in the query, it is possible to use allen, bob, and claire as nodes to satisfy node N0, completing even more of the partial match pattern solutions, and enabling another match path to be solved.

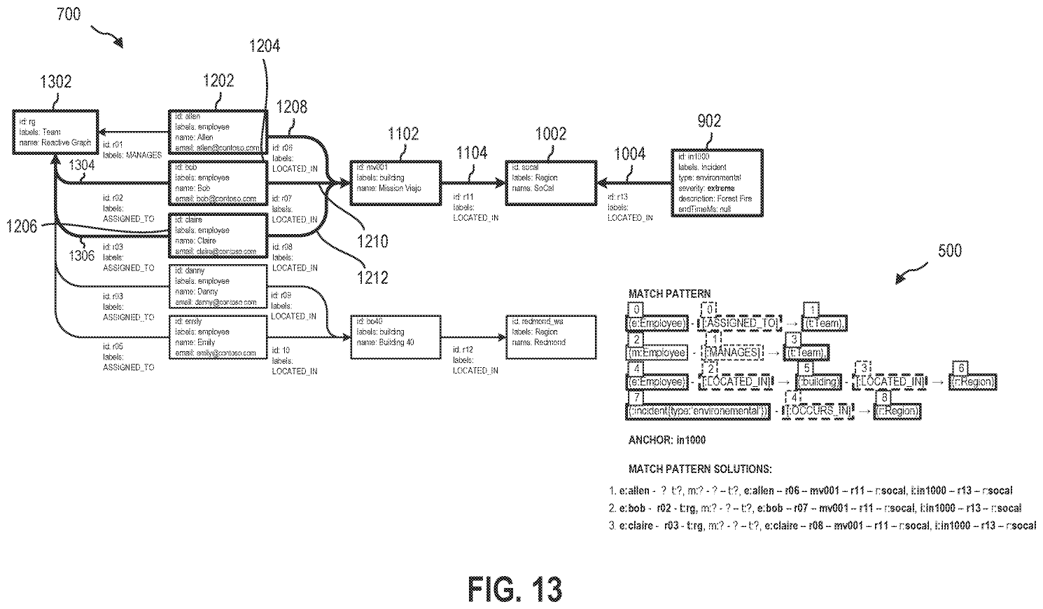

FIG. 13 illustrates the anchored node 902 and connected nodes 1002, 1102, 1202, 1204, 1206, and 1302 as part of a partial match pattern solution to the continuous query 12. The match pattern solver 60 processes each partial match pattern solution (3 different partial match pattern solutions). For each partial match pattern solution, the match pattern solver 60 queries the element cache 40 to find relations that satisfy relation R0 connected to the nodes that satisfy node N1. The match pattern solver 60 only finds results for two of the partial match pattern solutions. The third partial match pattern solution (where ‘e’=‘allen’) as no relation R0 or node N1. The third match pattern solution is marked as unsolvable and is abandoned.

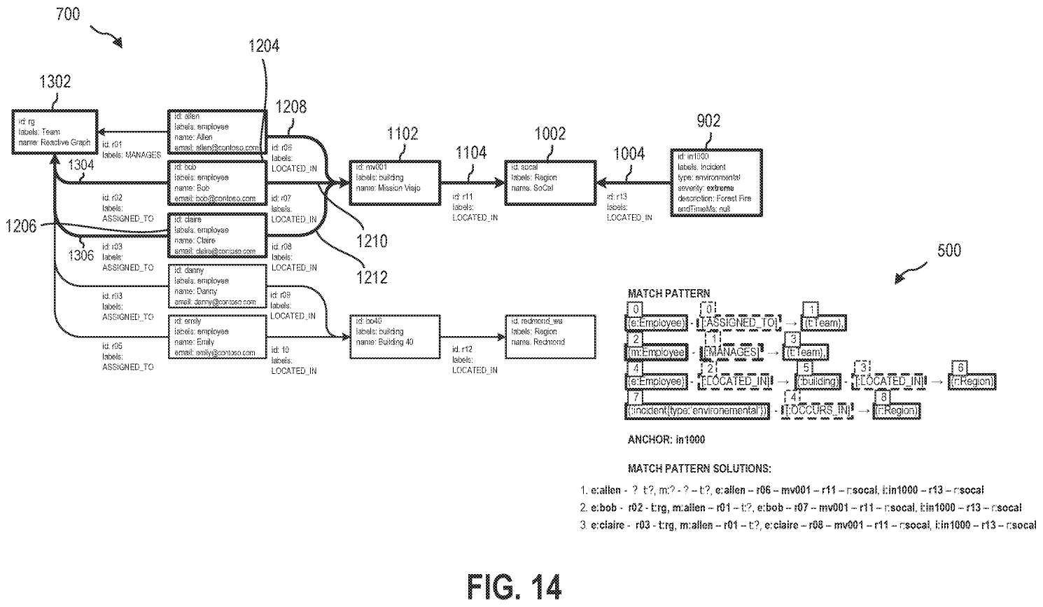

FIG. 14 illustrates the anchored node 902 and connected nodes 1002, 1102, 1204, 1206, and 1302 as the match pattern solutions 62 (FIG. 4) to the continuous query 12. The match pattern solver 60 completes the remaining two partial match pattern solutions by querying the element cache 40 once more to find relations that satisfy relation R1 connected to the nodes that satisfy node N2. The match pattern solver 60 finds two and completes both solutions. On completion, the match pattern solver 60 has 2 complete match pattern solutions 62 and 1 abandoned unsolvable match pattern solution.

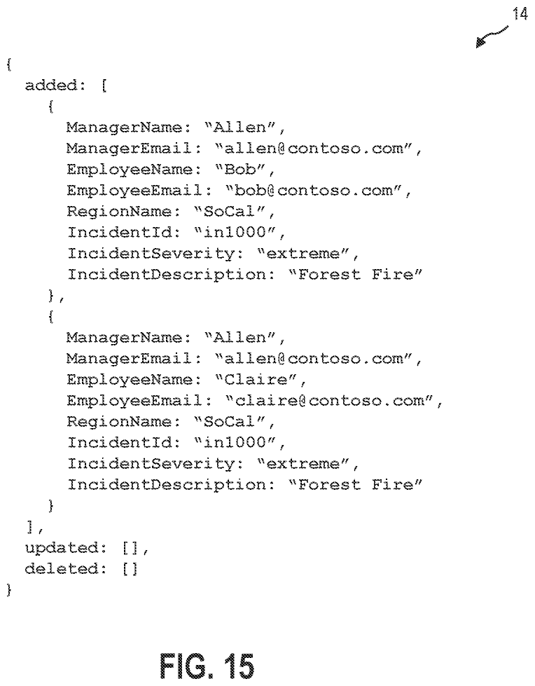

FIG. 15 illustrates example updates to a continuous query result 14 based on solving the continuous query 12 using anchored paths as discussed in FIGS. 9-14. The two complete match pattern solutions 62 are passed to the solution processor 66. The solution processor 66 queries the solution cache 42 to retrieve the set of match pattern solutions 64 the anchor node 902 (the changed element in1000) was part of prior to the change. Comparing the set of match pattern solutions 64 from before the change with the set of match pattern solutions 62 from after the change, the solution processor 66 can determine which solutions have been added or removed. The solution processor 66 can then project results from these solutions and determine which continuous query results 14 have been added, updated, and deleted. This set of query result updates 68 changes is both stored in the result store 44 and scheduled for dispatch from the dispatcher 38 to continuous query subscribers 110.

In this example, there were no match pattern solutions 64 containing the in1000 Node before the change, because the in1000 Node did not meet the query criteria (i.e., the in1000Node did not have the correct severity property value). The final results are dispatched to all continuous query subscribers 110 describing two additions to the continuous query result 14.

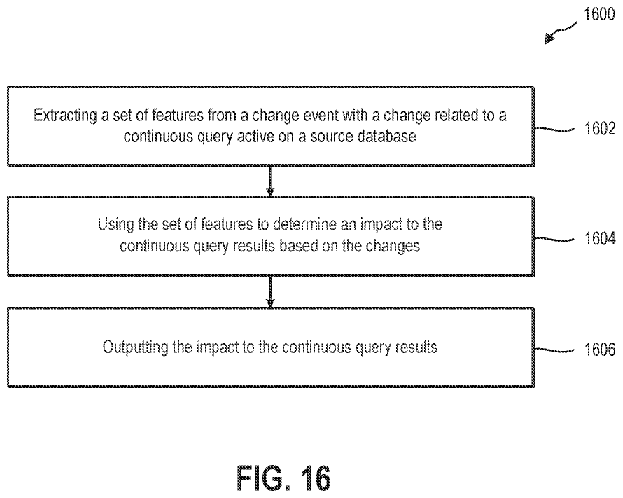

Referring now to FIG. 16, illustrated is an example method 1600 for an impact of a change on continuous query results. The actions of the method 1600 are discussed below with reference to the architectures of FIGS. 1-4.

At 1602, the method 1600 includes extracting a set of features from a change event with a change related to a continuous query active on a source database. The query host 34 extracts a set of features from a change event 26 with a change related to a continuous query 12 active on a source database 106. In some implementations, the change is related to the continuous query 12 in response to the set of features matching an element in an element feature vector of the continuous query 12. In some implementations, extracting the set of features is based on the match path elements included in a match pattern (e.g., the match pattern 502) of the continuous query 12. In some implementations, a minimum amount of features are extracted as the set of features to analyze the impact on to the continuous query results 14.

At 1604, the method 1600 includes using the set of features to determine an impact to the continuous query results based on the change. The query host 34 uses the set of features to determine an impact to the continuous query results 14 based on the change. In some implementations, the query host 34 accesses a graph (e.g., the graph 700) of the source database 106, identifies a node in the graph with the change using the set of features, and evaluates whether the change impacts the continuous query results 14 provided by the node. In some implementations, the graph includes data related to the continuous query 12. In some implementations, the change impacts the continuous query results 14 in response to a difference occurring between the continuous query results 14 using the node prior to the change occurring in the node and the continuous query results 14 after the change occurs in the node.

At 1606, the method 1600 includes outputting the impact to the continuous query results. The query hosts 34 outputs the impact to the continuous query results 14. In some implementations, the impact to the continuous query results 14 is a removal of a continuous query result from the continuous query results 14 in response to the change. In some implementations, the impact to the continuous query results 14 is an addition of a continuous query result to the continuous query results 14 in response to the change. In some implementations, the impact to the continuous query results 14 is updates to the continuous query results 14 in response to the change. In some implementations, the impact to the continuous query result 14 is no change to the continuous query results 14.

In some implementations, the method 1600 further includes causing a reaction 11 to occur in response to the impact to the continuous query results 14. For example, the reaction 11 is causing further processing on the continuous query results 14. Another example of the reaction 11 is automatically sending an e-mail in response to the impact on the continuous query results 14. Another example of the reaction 11 is storing the continuous query results 14.

As such, the method 1600 is used to monitor the changes in data of the source database 106 and determine whether the changes impact the continuous query results 14 of a continuous query 12.

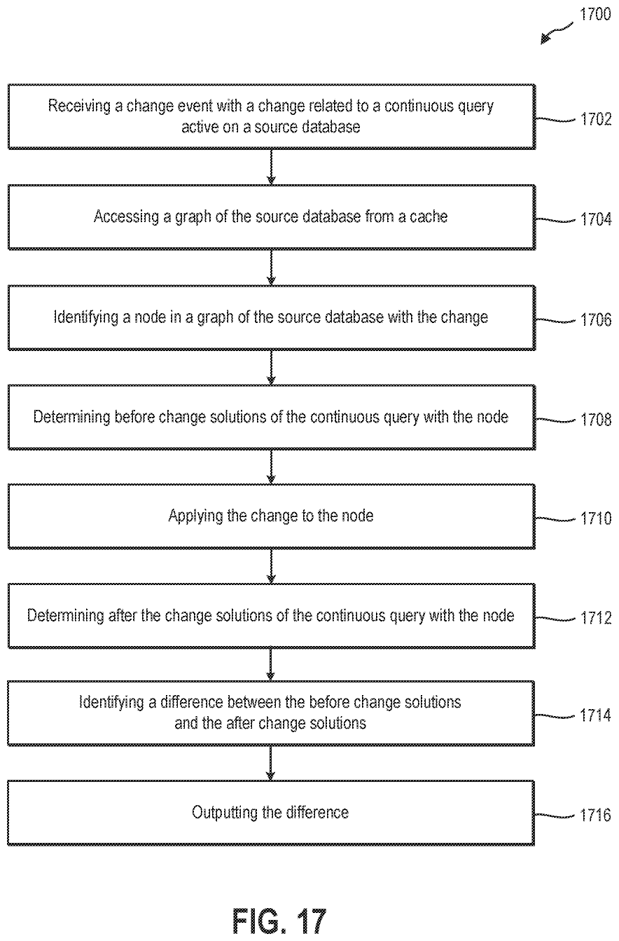

Referring now to FIG. 17, illustrated is an example method 1700 for an impact of a change on continuous query results. The actions of the method 1700 are discussed below with reference to the architectures of FIGS. 1-4.

At 1702, the method 1700 includes receiving a change event with a change related to a continuous query active on a source database. The query host 34 receives a change event 26 with a change related to a continuous query 12 active on a source database 106. In some implementations, the source database 106 is a graph database. The change is a modification (addition, removal, and/or change) of data in the source database 106.

In some implementations, the query host 34 determines whether the change is related to the continuous query 12 by accessing an element feature vector of the continuous query 12 (e.g., from an element cache 40). The query host 34 compares a set of features from the change event 26 to the element feature vector and determines that the change is related to the continuous query 12 in response to the set of features matching an element in the element feature vector of the continuous query 12.

At 1704, the method 1700 includes accessing a graph of the source database from a cache. The query host 34 accesses the graph (e.g., the graph 700) from a cache. In some implementations, the graph includes data related to the continuous query 12.

At 1706, the method 1700 includes identifying a node in a graph of the source database with the change. The query host 34 identifies a node (e.g., the node 902) in the graph (e.g., the graph 700) with the change. In some implementations, the query host 34 uses a node identification or other information in the change to identify which node in the graph changes.

At 1708, the method 1700 includes determining before change solutions of the continuous query with the node. The query host 34 performs a graph walk from the node (e.g., the node 902) using the graph (e.g., the graph 700) and identifies the before change solutions from the node (e.g., the node 902) that solve a match pattern (e.g., the match pattern 502) of the continuous query 12.

At 1710, the method 1700 includes applying the change to the node. The query host 34 applies the change to the node (e.g., the node 902) in the graph (e.g., the graph 700).

At 1712, the method 1700 includes determining after change solutions of the continuous query with the node. The query host 34 performs a graph walk from the node (e.g., the node 902) using the graph (e.g., the graph 700) and identifies the after change solutions from the node (e.g., the node 902) that solve a match pattern (e.g., the match pattern 502) of the continuous query 12.

At 1714, the method 1700 includes identifying a difference between the before change solutions and the after change solutions. The query host 34 identifies a difference between the before change solutions and the after change solutions. In some implementations, the differences identify changes to the continuous query results 14 based on the change to the node (e.g., the node 902).

At 1716, the method 1700 includes outputting the difference. The query host 34 outputs the difference. In some implementations, the difference identifies an impact to the continuous query results 14 in response to the change. In some implementations, the impact to the continuous query results 14 is a removal of query results. In some implementations, the impact to the continuous query results 14 is an addition of continuous query results. In some implementations, the impact to the continuous query results 14 is updates to the continuous query results 14. In some implementations, the impact to the continuous query results 14 is no change to the continuous query results 14.

Thus, the method 1700 uses a graph (e.g., the graph 700) of the source database 106 to analyze an impact of a change on the continuous query results 14. In some implementations, the method 1700 further includes causing a reaction 11 with an action to take for the continuous query results 14 based on the difference.

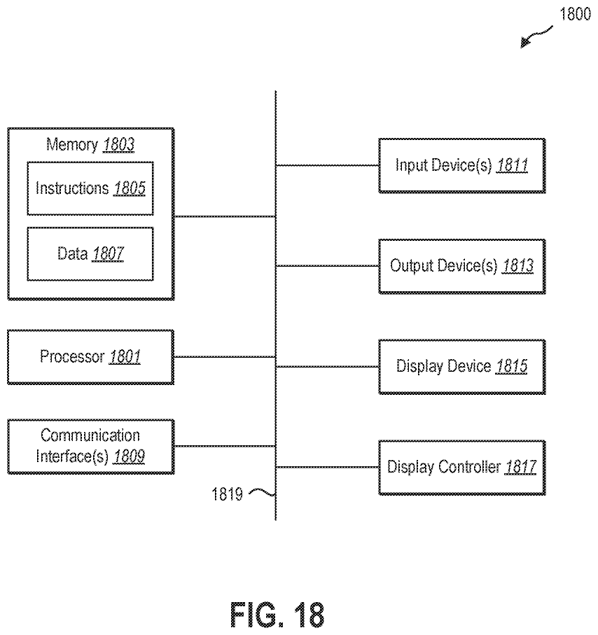

FIG. 18 illustrates components that may be included within a computer system 1800. One or more computer systems 1800 may be used to implement the various methods, devices, components, and/or systems described herein.

The computer system 1800 includes a processing system comprising a processor 1801. The processor 1801 may be a general-purpose single or multi-chip microprocessor (e.g., an Advanced Reduced Instruction Set Computer (RISC) Machine (ARM)), a special purpose microprocessor (e.g., a digital signal processor (DSP)), a microcontroller, a programmable gate array, etc. The processor 1801 may be referred to as a central processing unit (CPU). Although just a single processor 1801 is shown in the computer system 1800 of FIG. 18, in an alternative configuration, a combination of processors (e.g., an ARM and DSP) could be used.

The computer system 1800 also includes memory 1803 in electronic communication with the processor 1801. The memory 1803 may be any electronic component capable of storing electronic information. For example, the memory 1803 may be embodied as random access memory (RAM), read-only memory (ROM), magnetic disk storage mediums, optical storage mediums, flash memory devices in RAM, on-board memory included with the processor, erasable programmable read-only memory (EPROM), electrically EPROM memory, registers, and so forth, including combinations thereof.

Instructions 1805 and data 1807 may be stored in the memory 1803. The instructions 1805 may be executable by the processor 1801 to implement some or all of the functionality disclosed herein. Executing the instructions 1805 may involve the use of the data 1807 that is stored in the memory 1803. Any of the various examples of modules and components described herein may be implemented, partially or wholly, as instructions 1805 stored in memory 1803 and executed by the processor 1801. Any of the various examples of data described herein may be among the data 1807 that is stored in memory 1803 and used during execution of the instructions 1805 by the processor 1801.

A computer system 1800 may also include one or more communication interfaces 1809 for communicating with other electronic devices. The communication interface(s) 1809 may be based on wired communication technology, wireless communication technology, or both. Some examples of communication interfaces 1809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1800 may also include one or more input devices 1811 and one or more output devices 1813. Some examples of input devices 1811 include a keyboard, mouse, microphone, remote control device, button, joystick, trackball, touchpad, and lightpen. Some examples of output devices 1813 include a speaker and a printer. One specific type of output device that is typically included in a computer system 1800 is a display device 1815. Display devices 1815 used with embodiments disclosed herein may utilize any suitable image projection technology, such as liquid crystal display (LCD), light-emitting diode (LED), gas plasma, electroluminescence, or the like. A display controller 1817 may also be provided, for converting data 1807 stored in the memory 1803 into text, graphics, and/or moving images (as appropriate) shown on the display device 1815.

The various components of the computer system 1800 may be coupled together by one or more buses, which may include a power bus, a control signal bus, a status signal bus, a data bus, etc. For the sake of clarity, the various buses are illustrated in FIG. 18 as a bus system 1819.

As illustrated in the foregoing discussion, the present disclosure utilizes a variety of terms to describe features and advantages of the model evaluation system. Additional detail is now provided regarding the meaning of such terms.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, implementations of the disclosure can comprise at least two distinctly different kinds of computer-readable mediums: non-transitory computer-readable storage media (devices) and transmission media.

As used herein, non-transitory computer-readable storage mediums (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
receiving a change event with a change related to a continuous query active on a source database;
extracting a set of features from the change event, wherein the set of features are relevant to the continuous query;
discarding features in the change event unrelated to the continuous query;
using the set of features to determine an impact to continuous query results in response to the change;
outputting the impact to the continuous query results; and
causing a reaction with an action to take in response the impact to the continuous query results.

2. (canceled)

3. The method of claim 1, wherein extracting the set of features is based on match path elements included in a match pattern of the continuous query.

4. The method of claim 1, wherein a minimum amount of features are extracted as the set of features to analyze the impact on to the continuous query results.

5. The method of claim 1, wherein the change is related to the continuous query in response to the set of features matching an element in an element feature vector of the continuous query.

6. The method of claim 1, wherein determining the impact to the continuous query results further comprises:
accessing a graph of the source database, wherein the graph is data related to the continuous query;
identifying a node in the graph with the change using the set of features; and
evaluating whether the change impacts the continuous query results provided by the node.

7. The method of claim 6, wherein the change impacts the continuous query results in response to a difference occurring between the continuous query results using the node prior to the change occurring in the node and the continuous query results after the change occurs in the node.

8. The method of claim 1, wherein the impact to the continuous query results is a removal of a query result from the continuous query results in response to the change.

9. The method of claim 1, wherein the impact to the continuous query results is an addition of a query result to the continuous query results in response to the change or an update of the continuous query results.

10. The method of claim 1, wherein the impact to the continuous query results is no change to the continuous query results.

11. A system, comprising:
a processor;
memory in electronic communication with the processor; and
instructions stored in the memory, the instructions being executable by the processor to:
receive a change event with a change related to a continuous query active on a source database;
access a graph of the source database from a cache;
identify a node in a graph of the source database with the change;
determine before change solutions of the continuous query with the node;
apply the change to the node;
determine after change solutions of the continuous query with the node;
identify a difference between the before change solutions and the after change solutions;
ignore the query change event in response to determining continuous query results of the continuous query remain unchanged in response to the difference; and
cause a reaction with an action to take on the continuous query results in response to determining the difference impacts the continuous query results.

12. The system of claim 11, wherein the graph includes data related to the continuous query.

13. (canceled)

14. The system of claim 11, wherein the instructions are further executable by the processor to determine the before change solutions of the continuous query with the node by:
performing a graph walk from the node using the graph; and
identifying the before change solutions from the node that solve a match pattern of the continuous query.

15. The system of claim 11, wherein the instructions are further executable by the processor to determine the after change solutions with the node by:
performing a graph walk from the node using the graph; and
identifying the after change solutions from the node that solve a match pattern of the continuous query.

16. The system of claim 11, wherein the differences identify changes to the continuous query results based on the change to the node.

17. The system of claim 11, wherein the impact to the continuous query results is a removal of query results.

18. The system of claim 11, wherein the impact to the continuous query results is an addition of query results or changes to the query results.

19. The system of claim 11, wherein the impact to the continuous query results is no change to the continuous query results.

20. The system of claim 11, wherein the instructions are further executable by the processor to:
access an element feature vector of the continuous query;
compare a set of features from the change event to the element feature vector; and
determine that the change is related to the continuous query in response to the set of features matching an element in the element feature vector of the continuous query.
